(19) United States
(12) Patent Application Publication
(10) Pub. No.: US 2026/0246096 A1
(43) Pub. Date: Aug. 20, 2026

(54) BATTERY MODULE, BATTERY PACK AND VEHICLE INCLUDING THE BATTERY MODULE

(71) Applicant: LG ENERGY SOLUTION, LTD., Seoul (KR)

(72) Inventors: Seok-Hee KIM, Daejeon (KR); Dae-Han BAE, Daejeon (KR); Shin-Yong SHIN, Daejeon (KR); Yeong-Shin JO, Daejeon (KR); Hee-Yong KWON, Daejeon (KR)

(21) Appl. No.: 19/535,939

(22) Filed: Feb. 10, 2026

(30) Foreign Application Priority Data
Feb. 19, 2025 (KR) 10-2025-0021604

(51) Int. Cl. H01M 50/503; H01M 50/209

(52) U.S. Cl. CPC H01M 50/503; H01M 50/209; H01M 2220/20

(57) ABSTRACT

A battery module according to one embodiment of the present disclosure includes: a module case; a cell assembly that is accommodated in the module case and includes a plurality of battery cells; a busbar assembly that includes a busbar frame covering one side of the cell assembly and guiding the connection of electrode leads of the plurality of battery cells, and a terminal busbar electrically connected to the battery cells and configured for electrical connection to the outside; an insulating cover that covers the busbar frame and electrically insulates the electrode leads of the battery cells from the module case, and is provided with a terminal hole through which the end of the terminal busbar passes; and a sealing member that is hook-coupled to the insulating cover, and seals a gap between the terminal busbar and the terminal hole.

### CROSS-REFERENCE TO RELATED APPLICATIONS

This application is based on and claims priority from Korean Patent Application No. 10-2025-0021604 filed on Feb. 19, 2025, with the Korean Intellectual Property Office, the disclosure of which is incorporated herein in its entirety by reference.

### TECHNICAL FIELD

The present disclosure relates to a battery module, and a battery pack and a vehicle each including the battery module.

### BACKGROUND

As the demand for portable electronic products such as smartphones, tablet PCs, and smart watches significantly increases, and electric vehicles have become gradually widespread, research on the batteries mounted on these products including the electric vehicles, particularly, on the secondary batteries that are repeatedly chargeable and dischargeable, is actively being conducted.

Currently commercially available secondary batteries include nickel cadmium batteries, nickel hydrogen batteries, nickel zinc batteries, lithium secondary batteries, and the like. Among them, the lithium secondary batteries are subject to little memory effect compared to nickel-based secondary batteries, and thus are attracting attention due to advantages such as free charging/discharging, a very low self-discharge rate, and a high energy density.

The lithium secondary batteries mainly uses a lithium-based oxide and a carbon material as a positive electrode active material and a negative electrode active material, respectively. The lithium secondary batteries include an electrode assembly, and an external material that seals and accommodates the electrode assembly with an electrolyte, that is, a battery case. In the electrode assembly, a positive electrode plate and a negative electrode plate, which are coated with the positive electrode active material and the negative electrode active material, respectively, are disposed with a separator interposed therebetween. In general, according to the shape of the external material, the lithium secondary batteries may be classified into can-type secondary batteries, in which the electrode assembly is accommodated in a metal can, and pouch-type secondary batteries, in which the electrode assembly is housed in a pouch of an aluminum laminate sheet.

The secondary batteries have recently been widely used for driving or energy storage not only in small devices such as portable electronic devices, but also in medium- to large-sized devices such as electric vehicles and energy storage systems (ESSs).

In line with such a change in demand for secondary batteries, large-capacity secondary batteries are being developed and along with this, interest in safety issues of secondary batteries is increasing.

### SUMMARY

The present disclosure provides a battery module, and a battery pack and a vehicle each including the battery module. The structure of the battery module is improved such that a sealing member coupled to a terminal hole may maintain its stable coupling state even during a coupling process of an end plate.

Meanwhile, the technical scope of the present disclosure are not limited to the above-mentioned features, and other unmentioned features will be clearly understood by those skilled in the art from the description of the invention described below.

A battery module according to the present disclosure may include: a module case; a cell assembly that is accommodated in the module case and includes a plurality of battery cells; a busbar assembly that includes a busbar frame covering one side of the cell assembly and guiding the connection of electrode leads of the battery cells, and a terminal busbar electrically connected to the battery cells and configured for electrical connection to the outside; an insulating cover that covers the busbar frame and electrically insulates the electrode leads of the battery cells from the module case, and has a terminal hole through which the end of the terminal busbar passes; and a sealing member that is hook-coupled (Hook and Loop Fastener) to the insulating cover, and seals a gap between the terminal busbar and the terminal hole.

A module case assembly according to another embodiment of the present disclosure includes: a module case that accommodates a cell assembly including a plurality of battery cells; a busbar assembly that includes a busbar frame covering one side of the cell assembly accommodated in the module case and guiding the connection of electrode leads of the battery cells, and a terminal busbar electrically connected to the battery cells and configured for electrical connection to the outside; an insulating cover that covers the busbar frame and electrically insulates the electrode leads of the battery cells from the module case, and has a terminal hole through which the end of the terminal busbar passes; and a sealing member that is hook-coupled to the insulating cover, and seals a gap between the terminal busbar and the terminal hole.

According to the present disclosure, the sealing member includes a hook protruding in one direction, and the insulating cover includes a hook-catching groove to which the hook is inserted and coupled. The hook-catching groove may be formed such that the hook is allowed to be inserted upward from below.

The hook may be formed to have a rectangular cross-section.

The insulating cover may have a terminal through-hole through which the terminal busbar passes, and the hook may be disposed below the terminal through-hole.

The sealing member may include a coupling protrusion that is disposed on a side opposite to the hook with the terminal through-hole interposed therebetween, and is coupled to the insulating cover.

The insulating cover may include a coupling groove into which the coupling protrusion is forcibly fitted.

The sealing member may include a body provided with the terminal through-hole and attached to one surface of the insulating cover facing the busbar frame, an upper wing formed to extend upward from the body and provided with the coupling protrusion, and a lower wing formed to extend downward from the body and provided with the hook.

The body may include an O-ring having a ring shape corresponding to the terminal hole, protruding toward the opposite side of the busbar frame, passing through the terminal hole, and being in close contact with the inside surface of the terminal hole.

The O-ring may include a fitting groove concavely formed along the circumferential direction, into which the terminal hole is fitted.

The present disclosure provides a battery pack, for example, a battery pack including at least one battery module according to the present disclosure.

The present disclosure provides a vehicle, for example, a vehicle including the battery pack according to the present disclosure.

According to the battery module of the present disclosure, which includes the improved insulating cover and the sealing member, the sealing member may be stably coupled to the insulating cover, and the sealing member may be prevented or suppressed from being separated during the assembly process of the insulating cover and the end plate.

Also, since the sealing member of the battery module is exposed to the front of the insulating cover, an operator may visually and immediately check whether the sealing member is separated.

In addition, various other additional effects may be achieved by various embodiments of the present disclosure. These various effects of the present disclosure will be described in detail in each embodiment, and the description of effects that can be easily understood by those skilled in the art will be omitted.

### BRIEF DESCRIPTION OF THE DRAWINGS

The following drawings attached hereto illustrate embodiments of the present disclosure and serve to further understand the technical idea of the present disclosure together with the content of the disclosure described above. Therefore, the present disclosure should not be construed as being limited to the matters illustrated in the drawings.

FIG. 1 is a perspective view schematically illustrating the configuration of a battery module, according to one embodiment of the present disclosure.

FIG. 2 is an exploded perspective view of the battery module illustrated in FIG. 1.

FIG. 3 is a perspective view of a state where some of the components illustrated in FIG. 2 are assembled.

FIG. 4 is an exploded perspective view of the components illustrated in FIG. 3.

FIG. 5 is a perspective view of an insulating cover illustrated in FIG. 3, as seen from the rear toward the front.

FIG. 6 is a perspective view of a state where a sealing member is coupled to the insulating cover illustrated in FIG. 5.

FIG. 7 is a schematic perspective view of the sealing member, according to one embodiment of the present disclosure.

FIG. 8 is a view of the sealing member illustrated in FIG. 7, as seen in the direction of the arrow.

FIG. 9 is a perspective view of a state where the sealing member is coupled to the insulating cover.

FIG. 10 is a cross-sectional view taken along the line A-A' of FIG. 9.

FIG. 11 is a partial cut-away perspective view of the sealing member and the insulating cover illustrated in FIG. 9.

FIG. 12 is a view for explaining a battery pack, according to one embodiment of the present disclosure.

FIG. 13 is a view for explaining a vehicle, according to one embodiment of the present disclosure.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described in detail with reference to accompanying drawings. Prior to this, terms or words used in the present specification and claims should not be limitedly construed as usual or dictionary meanings, and should be interpreted as meanings and concepts consistent with the technical idea of the present disclosure on the basis of the principle that the inventor can appropriately define the concept of the term in order to explain his/her own invention in the best way.

Therefore, the embodiments described in this specification and the configurations illustrated in drawings are merely the most preferred embodiments of the present disclosure, and do not represent all of technical ideas of the present disclosure. Thus, it should be understood that there may be various equivalents and modifications that can replace them at the time of filing this application.

Meanwhile, although terms indicating directions, such as up, down, left, right, front, and back, may be used in the present specification, it is obvious to those skilled in the art of the present disclosure that these terms are only for convenience of explanation, and may vary depending on the location of a target object, the location of an observer, and the like.

Also, in the present specification, terms indicating directions, such as inside and outside, may be used. Unless otherwise specified, the inside may mean a direction toward the central portion of a battery module, and the outside may mean the opposite direction.

Also, the present specification includes various embodiments. Then, in the explanation on different embodiments, detailed descriptions on identical or similar parts will be omitted, and portions that differ among the embodiments will be mainly described.

In the embodiments of the present disclosure, the Y-axis direction illustrated in the drawings may refer to a left-right direction, the X-axis direction may refer to a front-rear direction perpendicular to the Y-axis direction on a horizontal plane (e.g., an X-Y plane), and the Z-axis direction may refer to an up-down direction (e.g., a vertical direction) perpendicular to both the X-axis direction and the Y-axis direction. Then, in the orthogonal coordinate system illustrated in the drawings, each axis has + and - directions. X, Y and Z indicated in the drawings may mean + directions, and the opposite directions may mean - directions.

A plurality of secondary batteries may be accommodated together inside a module case while being electrically connected to each other, thereby forming a configuration of one battery module. Here, each secondary battery included in one battery module may be referred to as a battery cell. Then, a plurality of such battery modules may be connected to each other to constitute a battery pack.

The configuration of a conventional battery module includes a plurality of battery cells, a busbar assembly for electrical connection of the plurality of battery cells, and a module case accommodating the busbar assembly and the battery cells.

The busbar assembly may include a busbar frame, a busbar, and a terminal busbar. The busbar frame supports electrode leads of battery cells, and guides the connection of the electrode leads. The busbar and the terminal busbar are electrically connected to the electrode leads of the battery cells, and the terminal busbar may be electrically connected to external devices, for example, another battery module or an inter-module busbar constituting a battery pack. Then, an insulating cover for insulation between the module case and the electrode leads may be coupled to the front side of the busbar frame.

Meanwhile, the end of the terminal busbar is exposed to the outside of the insulating cover and is placed in the form of a terminal. To this end, the insulating cover is provided with a terminal hole through which the terminal busbar passes. However, when the battery cell is ignited, high-temperature gas and by-products may be emitted to the outside through the terminal hole. This may cause a problem in that an adjacent battery module or an inter-module busbar may be damaged.

In order to solve the above-mentioned problems, a sealing member may have conventionally been coupled to the terminal hole so as to seal a gap between the terminal busbar and the terminal hole. However, in a state where the sealing member is coupled in this way, the sealing member may be detached or separated from the terminal hole when an end plate is coupled to the insulating cover which is problematic.

In consideration of these issues, the present disclosure provides a battery module with an improved insulating cover and sealing member. In the provided technology, the sealing member may be stably coupled to the insulating cover, and prevented from being separated during the assembly process of the insulating cover and the end plate.

Hereinafter, embodiments of the present disclosure will be described with the drawings.

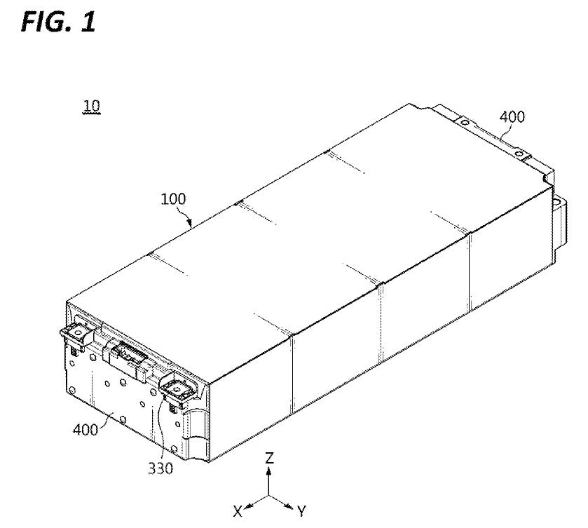

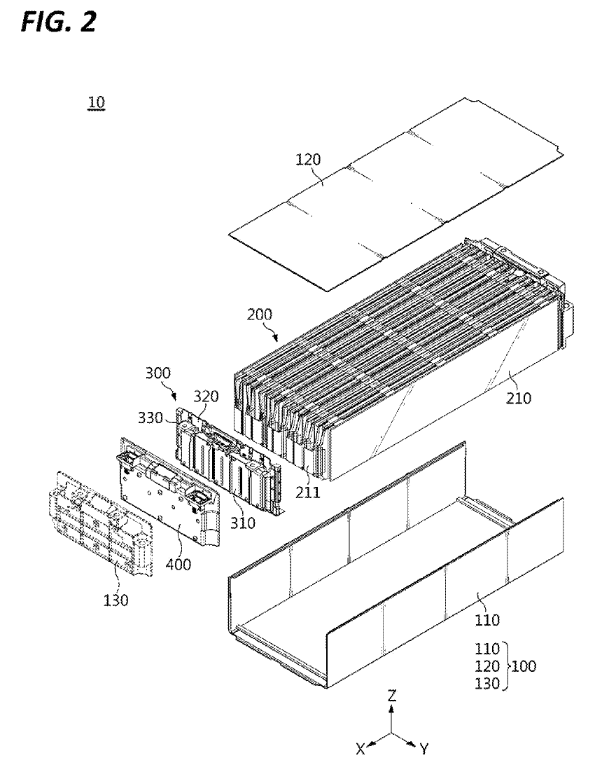

FIG. 1 is a perspective view schematically illustrating the configuration of a battery module, according to one embodiment of the present disclosure. FIG. 2 is an exploded perspective view of the battery module illustrated in FIG. 1.

Referring to FIGS. 1 and 2, a battery module 10, according to one embodiment of the present disclosure, may include a module case 100, a cell assembly 200, and a busbar assembly 300.

The module case 100 has a space formed therein, and in this configuration, the cell assembly 200 may be accommodated. For example, as illustrated in FIG. 2, the module case 100 may include a body frame 110 that is formed with a structure in which both ends and the top are open, and an upper cover 120 that covers the top of the body frame 110. Also, as illustrated by virtual lines in FIG. 2, the module case 100 may include end plates 130 that cover both ends of the body frame 110. For reference, FIG. 2 illustrates only one end plate 130 provided on the front side. This type of body frame 110 may be configured with a structure where a left plate, a right plate, and a lower plate are integrated with each other, which may be referred to as a U-frame.

In addition, the module case 100 may be formed in various other forms. For example, a structure where the left plate, the right plate, and the lower plate of the body frame and the upper cover are integrated may be formed. This body frame 110 may also be referred to as a mono frame. Meanwhile, the body frame 110 may not have an integrated structure, but another structure may be configured in which, for example, the left plate, the right plate, the lower plate, and the upper cover 120, which are provided independently of each other, are combined with each other.

Individual components of the module case 100, for example, the body frame 110, the upper cover 120, and the end plate 130 may be combined with each other in various ways such as welding, insertion, adhesion, and hook-catching. Also, the module case 100 may be made of various materials such as metal or plastic. According to one embodiment, the body frame 110, the upper cover 120, and the end plate 130 may be all made of an aluminum material. In this case, mutual weldability is excellent, it is advantageous for weight reduction, and cooling performance may also be improved.

The cell assembly 200 may include a plurality of battery cells 210. Here, each battery cell 210 may be a secondary battery. The secondary battery may include an electrode assembly, an electrolyte, and a battery case. For example, the battery cell 210 may be a pouch-type secondary battery.

The battery cells 210 may be stacked side by side in at least one direction. For example, as illustrated in FIG. 2, the battery cells 210 may be stacked side by side in the left-right direction (e.g., a Y-axis direction). Here, each battery cell 210 may be configured in a vertically erected form (e.g., a Z-axis direction).

Here, in order to more stably maintain the stacked state of the cell assembly 200, the battery cells 210 may be adhered to each other. For example, a cell adhesive member may be interposed between the battery cells 210. Here, the cell adhesive member may be configured in the form of a double-sided adhesive tape. The double-sided adhesive tape includes an adhesive applied to both sides of a substrate.

The busbar assembly 300 may be configured for electrical connection of the plurality of battery cells 210. The busbar assembly 300 may be connected to electrode leads 211 of the battery cells 210. Furthermore, the electrode leads 211 of the battery cells 210 may be located at both front and rear ends of the cell assembly 200. In this case, the busbar assemblies 300 may be disposed on the front side and the rear side of the cell assembly 200 (e.g., an X-axis direction), respectively.

According to one embodiment, the busbar assembly 300 may include a busbar 310, a busbar frame 320, and a terminal busbar 330. Here, the busbar 310 may be electrically connected to the cell assembly 200. For example, the busbar 310 may be made of a conductive metal material such as copper, and may be in direct contact with the electrode lead 211. The busbar frame 320 may be made of an electrically insulating material such as plastic, and the busbar 310 may be mounted on the busbar frame 320 so that the position of the busbar 310 may be fixed. To this end, the busbar frame 320 may be provided with a space or a structure on which the busbar 310 can be mounted.

Meanwhile, the electrode leads 211 may also be welded to each other and directly connected with no intervening busbar 310. In this case, the busbar assembly 300 may not include the busbar 310. Also, the busbar frame 320 may also be equipped with a sensing plate capable of measuring, for example, the current, the temperature, and the voltage of the battery cells 210.

The terminal busbar 330 may be electrically connected to the plurality of battery cells 210. For example, the terminal busbar 330 may be electrically connected to the busbars 310, and through this, may be electrically connected to the battery cells 210. The terminal busbar 330 may be one of the above-mentioned busbars 310. Here, for example, the terminal busbar 330 may be formed to be longer than other busbars 310, and have a bent-shaped end. Then, the bent end of the terminal busbar 330 may be utilized as a module terminal. Meanwhile, the plurality of electrically connected battery cells 210 may be connected to other components present outside the battery module 10, for example, another battery module or a charging/discharging system. The bent end of the terminal busbar 330, for example, the module terminal, may be a gateway to an electrical path, which is provided to allow the charging and discharging current for the cell assembly 200 to flow therethrough, and to allow this charging/discharging current to be connected to other components located outside the battery module 10.

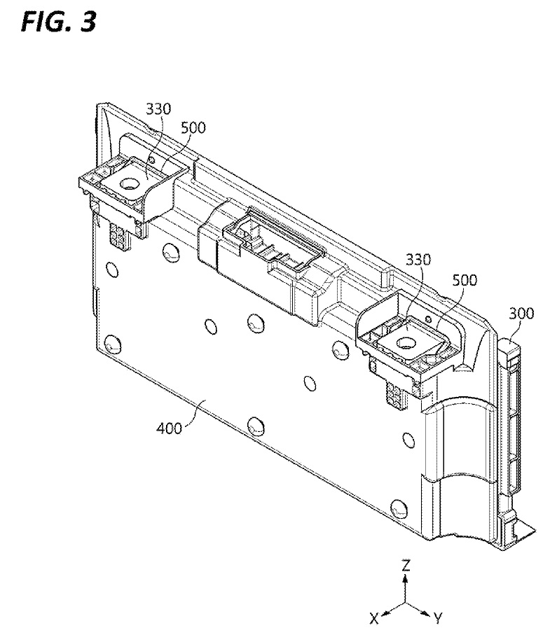

Referring back to FIG. 2, the battery module 10 according to the present embodiment may further include an insulating cover 400 and a sealing member in addition to the module case 100, the cell assembly 200, and the busbar assembly 300. Hereinafter, descriptions will be continued with further reference to FIGS. 3 to 7.

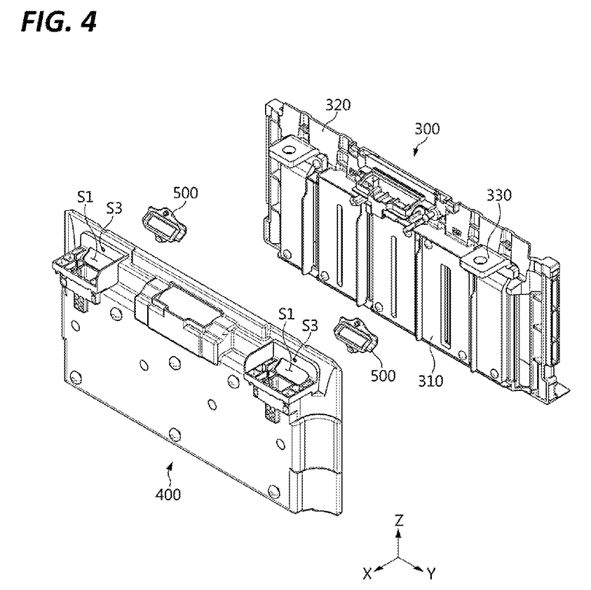

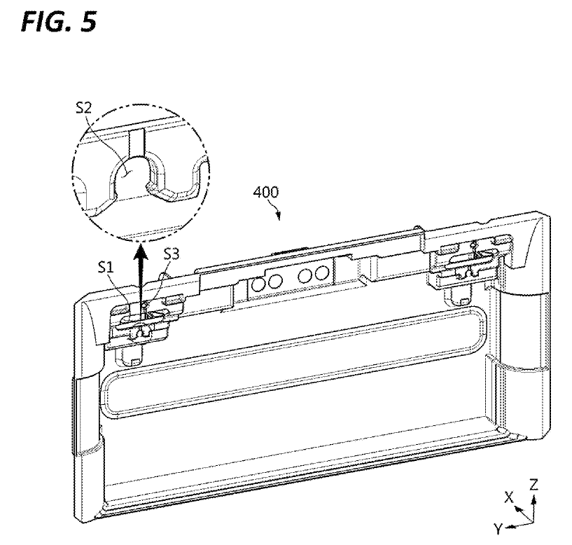

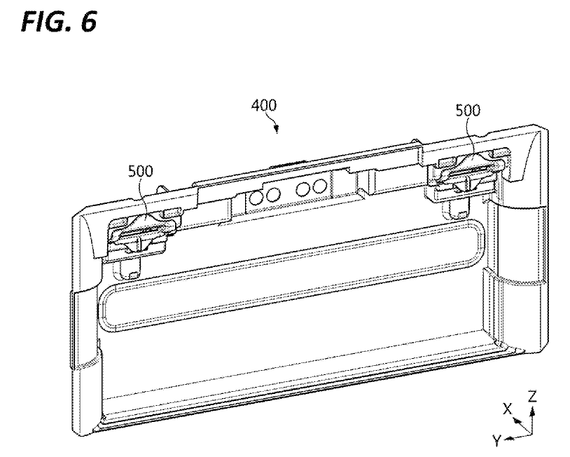

FIG. 3 is a perspective view of a state where some of the components illustrated in FIG. 2 are assembled, FIG. 4 is an exploded perspective view of the components illustrated in FIGS. 3, 5, is a perspective view of the insulating cover illustrated in FIG. 3, as seen from the rear toward the front, and FIG. 6 is a perspective view of a state where the sealing member is coupled to the insulating cover illustrated in FIG. 5.

Referring to FIGS. 2 to 6, the battery module 10, according to the present embodiment, further includes the insulating cover 400 and a sealing member 500.

The insulating cover 400 may be configured for electrical insulation of the electrode leads 211 of the battery cells 210. According to one embodiment, the insulating cover 400 may include a material having electrical insulation properties. For example, the insulating cover 400 may include a polymer material such as plastic. According to another embodiment, the insulating cover 400 may include a modified polyphenylene oxide (MPPO) material.

The insulating cover 400 may be interposed between the front side of the cell assembly 200 and the module case 100. According to one embodiment, the insulating cover 400 may be coupled to the busbar frame 320 to cover the busbar frame 320. The insulating cover 400 may be disposed between the electrode leads 211 connected on the busbar frame 320 and the end plate 130 of the module case 100, and thus, electrical insulation between the electrode leads 211 and the end plate 130 may be ensured.

The insulating cover 400 may be provided with a terminal hole S1. As illustrated in FIG. 4, the terminal hole S1 may be formed through the insulating cover 400. Then, the terminal busbar 330 may pass through the inside of the terminal hole S1. For example, the bent portion of the terminal busbar 330 may pass through the terminal hole S1.

The sealing member 500 may be configured to seal a gap between the terminal hole S1 and the terminal busbar 330. For example, the sealing member 500 may be coupled to the insulating cover 400 to seal the gap between the terminal busbar 330 and the terminal hole S1. The sealing member 500 may include a material having a predetermined elasticity such as rubber.

In the present embodiment, the sealing member 500 may be hook-coupled (e.g., Hook and Loop Fastener) to the insulating cover 400. The hook-fastening is a method of coupling two components to each other, and may be a method in which one component is hooked to and coupled to another component. The hook-fastening method may be a method of easily coupling two components. Then, the two hook-coupled components may maintain their stable coupling state as long as an external force is not applied in a specific direction. Here, the specific direction may be a direction opposite to a direction in which one component has moved until it is hook-coupled to another component. This will be described further later with an example.

According to the embodiment with the above-mentioned configuration, the sealing member 500 may be readily coupled to the insulating cover 400 through the hook-coupling method. Also, even during the process of coupling the end plate 130 to the insulating cover 400, it is possible to maintain a stable coupling state between the sealing member 500 and the insulating cover 400.

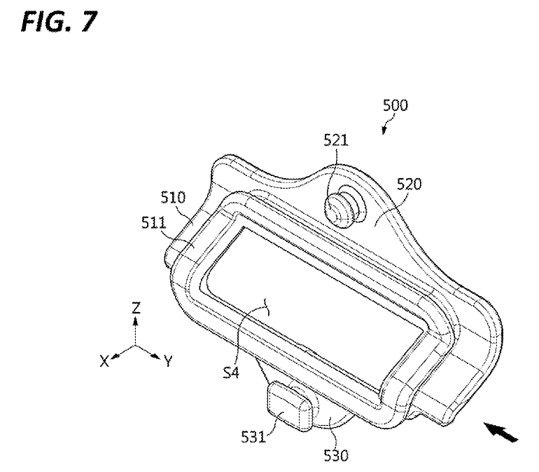

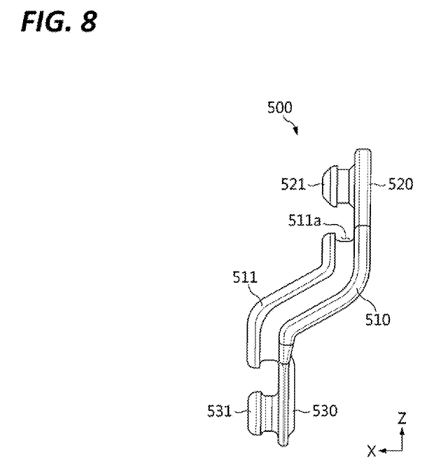

Hereinafter, descriptions will be made on the shapes of the insulating cover 400 and the sealing member 500, and the structure in which these components are hook-coupled. FIG. 7 is a schematic perspective view of the sealing member 500, according to one embodiment of the present disclosure, and FIG. 8 is a view of the sealing member 500 illustrated in FIG. 7, as seen in the direction of the arrow.

Referring to FIGS. 7 and 8, the sealing member 500 may include a hook 531. According to one embodiment, the hook 531 may be formed to protrude in one direction, for example, the forward direction (e.g., an X-axis direction) with reference to FIG. 7. As illustrated in FIG. 8, the hook 531 may be formed in a shape where the front end thereof expands outward.

The insulating cover 400 may be provided with a hook-catching groove S2. Here, the hook-catching groove S2 may be formed such that the hook 531 may be allowed to be inserted from below to the upward. For example, as illustrated in FIG. 5, the hook-catching groove S2 may be provided on the rear surface of the insulating cover 400, for example, the surface facing the busbar frame 320. The hook-catching groove S2 may be formed in a shape corresponding to the hook 531, and the hook 531 may be inserted into the hook-catching groove S2. Here, the hook-catching groove S2 may be concavely formed in an upward direction (e.g., a Z-axis direction), and thus, the hook 531 may be inserted from below to upward.

According to the above-mentioned configuration of the embodiment, the hook 531 may be inserted upward and hook-coupled while sliding along the hook-catching groove S2. Therefore, the sealing member 500 may be readily coupled to the insulating cover 400. The hook 531 inserted into the hook-catching groove S2 may be detached when moved in a direction opposite to the direction of insertion, for example, from the upper side toward the lower side (e.g., when an external force is applied), and may maintain its stable coupling state in other directions.

In a conventional case, when the end plate 130 is coupled to the insulating cover 400, the sealing member 500 may be pushed upward due to the actions such as deformation of the insulating cover 400 pressed by the end plate 130. Then, this may cause a problem in that the sealing member 500 may be detached from the terminal hole S1.

However, in the configuration of the present embodiment, the hook 531 of the sealing member 500 is configured to maintain the stable coupling even when subjected to an upward force. Thus, the above-mentioned problem may be prevented or suppressed. Therefore, it is possible to minimize the possibility that the sealing member 500 is detached from the terminal hole S1.

According to another embodiment of the present disclosure, the hook 531 may be formed to have a rectangular cross-section. For example, as illustrated in FIG. 7, the cross-section of the hook 531, for example, the cross-section on the YZ plane, may be formed in a roughly rectangular shape.

For example, in a case where the hook 531 has a circular cross-section, when the hook 531 is inserted into the hook-catching groove S2, a portion of the hook-catching groove S2 where both side surfaces of the hook (e.g., Y-axis direction) abut against the inside surface of the hook-catching groove, for example, an area where both side surfaces of the hook 531 are supported, may be relatively small. In contrast, in the present embodiment, since the hook 531 has a rectangular cross-section, both side surfaces of the hook 531 may be in contact with both inside surfaces of the hook-catching groove S2 in a plane-to-plane manner. Therefore, in a state where the hook 531 is inserted into the hook-catching groove S2, the rotation of the hook 531 about the X-axis direction as a rotation-axis direction may be restricted. As a result, the sealing member 500 may be prevented or suppressed from being twisted (e.g., twisting while rotating about the X-axis direction), and thus, the coupling state of the sealing member 500 may be more stably maintained. Meanwhile, as for the cross-section of the hook 531, a circular shape or a rectangular shape may be selected depending on the application environment, and one of the shapes does not consistently have superior performance or effect compared to the other.

A terminal through-hole S4 may be formed in the sealing member 500. For example, as illustrated in FIG. 7, the terminal through-hole S4 may be formed in the central portion of the sealing member 500. The bent portion of the terminal busbar 330 may pass through the terminal through-hole S4.

The hook 531 may be disposed below the terminal through-hole S4. Then, by disposing the hook 531 below the terminal through-hole S4 in this manner, the hook 531 may be stably coupled to the insulating cover 400. Descriptions will be made further with reference to FIGS. 6 and 7. In a state where the sealing member 500 is coupled to the insulating cover 400, the terminal busbar 330 may protrude through the terminal through-hole S4. Here, while the terminal busbar 330 passes through the terminal through-hole S4, the friction between the terminal busbar 330 and the sealing member 500 may cause a phenomenon in which the sealing member 500 is pulled by the terminal busbar 330. For example, a phenomenon similar to that of the terminal through-hole S4 portion of the sealing member 500 being pulled forward may occur.

Since the hook 531 according to the present embodiment is disposed below the terminal through-hole S4, the hook 531 may be pulled upward. Here, as described above, the hook 531 is coupled to the insulating cover 400 such that the hook-fastening is released only when an external force is applied downward. Therefore, even when the hook 531 is pulled upward, a stable coupling state between the sealing member 500 and the insulating cover 400 may be maintained. Meanwhile, the location of the hook 531 may be selected depending on the application environment, and one location does not consistently have superior performance or effect compared to the other location.

The sealing member 500 may further include a coupling protrusion 521 to be coupled to the insulating cover 400. For example, the coupling protrusion 521 may be formed to protrude forward in the same direction as the hook 531 (e.g., an X-axis direction). The cross-section of the coupling protrusion 521, for example, the cross-section on the YZ plane, may be formed in a circular shape. The coupling protrusion 521 may be disposed on the opposite side of the hook 531 with the terminal through-hole S4 interposed therebetween. For example, as illustrated in FIG. 7, the coupling protrusion 521 may be disposed above the terminal through-hole S4, and the terminal through-hole S4 may be disposed between the coupling protrusion 521 and the hook 531. The coupling protrusion 521 may be coupled to the insulating cover 400. Accordingly, the sealing member 500 may be coupled to the insulating cover 400 at portions above and below the terminal through-hole S4.

The coupling protrusion 521 may be coupled to a coupling groove S3 of the insulating cover 400. As illustrated in FIG. 5, the coupling groove S3 may be provided in the insulating cover 400. Here, the coupling groove S3 may be formed through the insulating cover 400. Also, the coupling groove S3 may be formed to have a cross-sectional area smaller than that of the coupling protrusion 521 of the sealing member 500. The coupling protrusion 521 of the sealing member 500 may be fitted to the coupling groove S3 of the insulating cover 400 by an external force through a forced fitting method, and thus the coupling protrusion 521 may be firmly and easily coupled to the insulating cover 400.

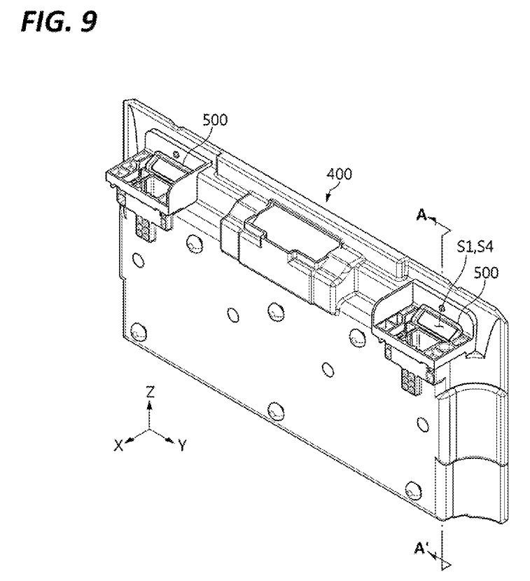

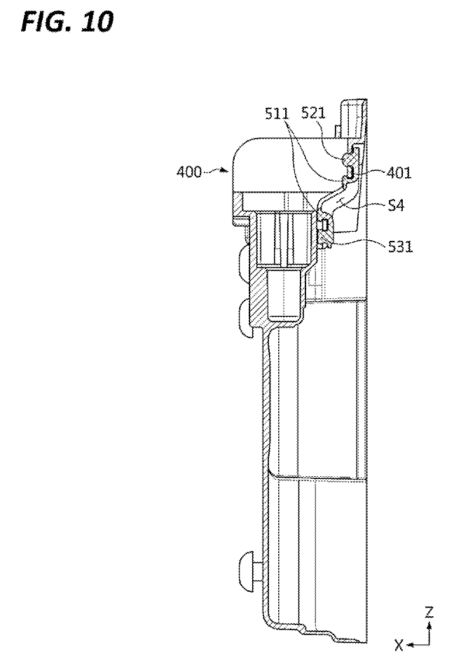

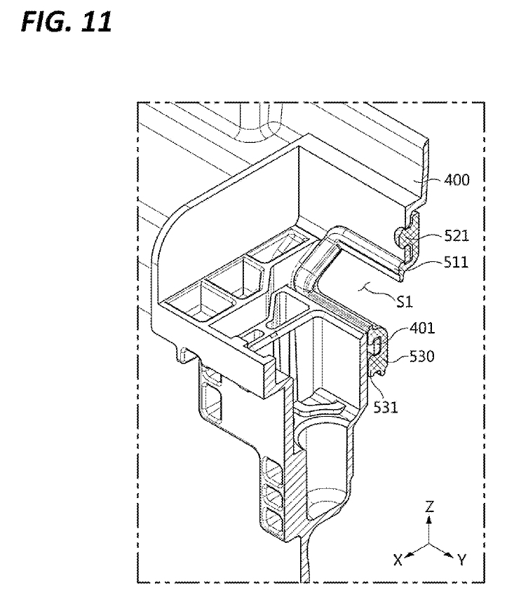

FIG. 9 is a perspective view of a state where the sealing member 500 is coupled to the insulating cover 400, FIG. 10 is a cross-sectional view taken along the line A-A' of FIGS. 9 and 11, is a partial cut-away perspective view of the sealing member 500 and the insulating cover 400 illustrated in FIG. 9.

Hereinafter, descriptions will be made on the shape and coupling structure of the sealing member 500 with reference to FIGS. 9 to 11 as well as FIGS. 7 and 8.

Referring to FIGS. 7 to 11, the sealing member 500 according to the present embodiment may include a body 510, an upper wing 520, and a lower wing 530.

The terminal through-hole S4 may be provided in the body 510. The body 510 may be coupled to the rear surface of the insulating cover 400. Here, as illustrated in FIG. 9, the body 510 may be coupled to the rear surface of the insulating cover 400 such that the terminal through-hole S4 and the terminal hole S1 of the insulating cover 400 are aligned. Also, an O-ring 511 may be provided in the body 510. The O-ring 511 may be configured to substantially seal a gap between the terminal busbar 330 and the terminal hole S1. The O-ring 511 may be formed in a ring shape corresponding to the shape of the terminal hole S1. The O-ring 511 is formed to protrude from the body 510, and may be formed to protrude in a direction opposite to the busbar frame, for example, toward the front side (e.g., an X-axis direction). As illustrated in FIG. 11, the O-ring 511 of the sealing member 500 protrudes forward through the terminal hole S1 of the insulating cover 400, and may be in close contact with the inside surface of the terminal hole S1. Here, the inside surface of the terminal hole S1 may mean the surface of a rim forming the boundary of the terminal hole.

The upper wing 520 of the sealing member 500 may be formed to extend upward from the body 510. The above-mentioned coupling protrusion 521 may be provided on the upper wing 520. When the coupling protrusion 521 of the sealing member 500 is coupled to the coupling groove S3 of the insulating cover 400, the upper wing 520 of the sealing member 500 may be attached to and supported by the rear surface of the insulating cover 400.

The lower wing 530 of the sealing member 500 may be formed to extend downward from the body 510. The hook 531 may be provided on the lower wing 530. When the hook 531 is coupled to the hook-catching groove S2 of the insulating cover 400, the lower wing 530 may be attached to and supported by the rear surface of the insulating cover 400.

As described above, the configuration of the sealing member 500 may include the upper wing 520, the body 510, and the lower wing 530 in this order from top to bottom. For example, the body 510 of the sealing member 500 may be formed to extend downward from the upper wing 520. Here, the body 510 may be formed to extend in a forwardly inclined direction rather than in a vertical direction.

According to the embodiment with the above-mentioned configuration, the sealing member 500 may be coupled to the insulating cover 400 on both sides of the terminal hole S1 of the insulating cover 400, for example, on the upper and lower sides of the terminal hole S1 of the insulating cover 400. Here, the upper wing 520 and the lower wing 530 may be stably attached to the rear surface of the insulating cover 400 while making surface contact with the rear surface.

The O-ring 511 may be in close contact with the terminal hole S1, and at the same time, may also be in close contact with the terminal busbar 330 passing through the terminal hole S1. Therefore, a gap between the terminal busbar 330 and the terminal hole S1 may be effectively sealed. Also, the O-ring 511 protrudes toward the front side of the insulating cover 400 through the terminal hole S1. Therefore, an operator may visually check the coupling state of the sealing member 500 instantly, for example, the operator may visually check whether the sealing member 500 is detached.

The O-ring 511 may be provided with a fitting groove 511a. For example, as illustrated in FIG. 8, the fitting groove 511a may be formed concavely along the circumferential direction of the O-ring 511. As illustrated in FIGS. 10 and 11, when the O-ring 511 is coupled to the terminal hole S1, a rim 401 of the terminal hole may be fitted into the fitting groove 511a. Therefore, the sealing effect of the O-ring 511 may be enhanced, and also the O-ring 511 may be more stably coupled to the terminal hole S1.

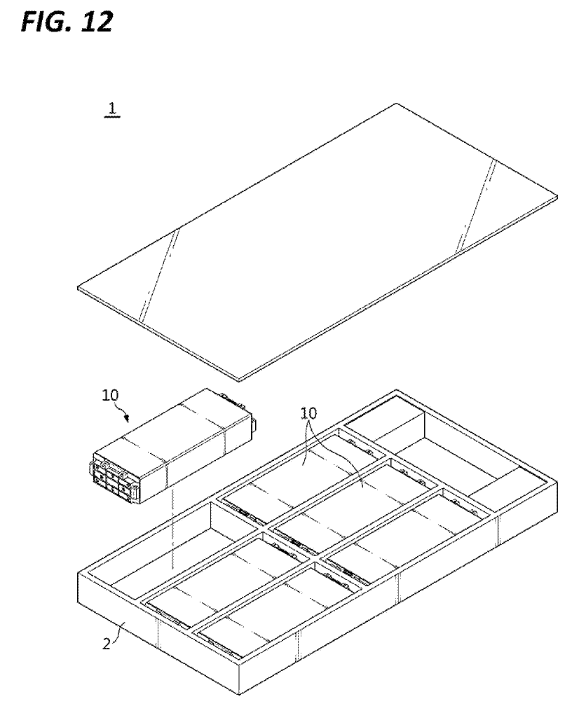

FIG. 12 is a view for explaining a battery pack, according to one embodiment of the present disclosure.

A battery pack 1 according to the present disclosure may include at least one battery module 10 described above, and may also include a pack case 2 that accommodates the battery module 10. Also, the battery pack 1 may further include various battery pack components known at the time of filing this disclosure, such as a BMS, a busbar, a relay, and a current sensor.

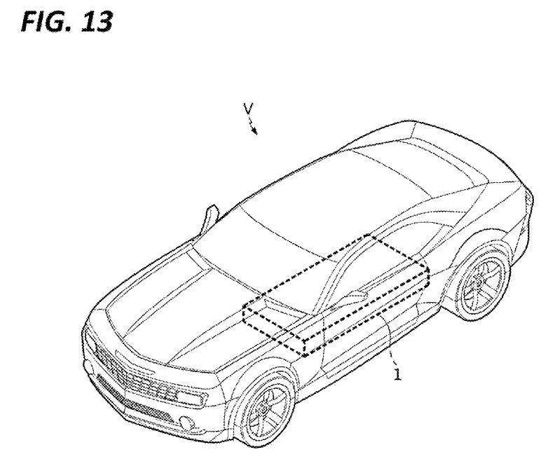

FIG. 13 is a view for explaining a vehicle, according to one embodiment of the present disclosure.

The battery pack 1 may be provided in a vehicle V, as a fuel source for the vehicle. For example, the battery pack 1 may be provided in electric vehicles and hybrid vehicles, and provided in vehicles V in any other manner that allows other battery packs 1 to be used as a fuel source.

The battery pack 1 and the vehicle V, according to the present embodiment, are provided with the battery module 10 of the foregoing embodiment, and thus, it is possible to realize the battery pack 1 and the vehicle V having all the advantages through the battery module 10 of the foregoing embodiment.

In addition, the battery pack 1 may well be provided not only in the vehicle V but also in other devices, apparatuses, or facilities that use a secondary battery, such as a power storage device.

While the present disclosure has been described above with reference to several embodiments and drawings, the present disclosure is not limited thereto, and various changes and modifications can be made by a person ordinarily skilled in the art to which the present disclosure pertains without departing from the technical spirit of the present disclosure and the equivalent scope of the claims to be described below.

What is claimed is:

1. A battery module comprising:
a module case;
a cell assembly accommodated in the module case and including a plurality of battery cells;
a busbar assembly including a busbar frame configured to cover one side of the cell assembly and guide connection of electrode leads of the plurality of battery cells, and a terminal busbar electrically connected to the plurality of battery cells and configured for electrical connection to an outside;
an insulating cover configured to cover the busbar frame and electrically insulate the electrode leads of the battery cells from the module case, and having a terminal hole through which an end portion of the terminal busbar passes; and
a seal hook-coupled to the insulating cover, and configured to seal a gap between the terminal busbar and the terminal hole.

2. The battery module according to claim 1, wherein the seal includes a hook protruding in one direction, and
the insulating cover includes a hook-catching groove into which the hook is inserted and coupled, the hook-catching groove being formed such that the hook is inserted upward from below.

3. The battery module according to claim 2, wherein the hook is formed to have a rectangular cross-section.

4. The battery module according to claim 2, wherein the insulating cover has a terminal through-hole through which the terminal busbar passes, and
the hook is disposed below the terminal through-hole.

5. The battery module according to claim 4, wherein the seal includes a coupling protrusion disposed on a side opposite to the hook with the terminal through-hole interposed therebetween and configured to be coupled to the insulating cover.

6. The battery module according to claim 5, wherein the insulating cover includes a coupling groove into which the coupling protrusion is forcibly fitted.

7. The battery module according to claim 6, wherein the seal includes:
a body provided with the terminal through-hole and attached to one surface of the insulating cover facing the busbar frame,
an upper wing formed to extend upward from the body and provided with the coupling protrusion, and
a lower wing formed to extend downward from the body and provided with the hook.

8. The battery module according to claim 7, wherein the body includes an O-ring having a ring shape corresponding to the terminal hole, the O-ring protruding toward the opposite side of the busbar frame, passing through the terminal hole, and being in close contact with an inside surface of the terminal hole.

9. The battery module according to claim 8, wherein the O-ring includes a fitting groove concavely formed along a circumferential direction, into which the terminal hole is fitted.

10. A battery pack comprising the battery module according to claim 1.

11. A vehicle comprising the battery pack according to claim 10.

12. A module case assembly comprising:
a module case configured to accommodate a cell assembly including a plurality of battery cells;
a busbar assembly including a busbar frame configured to cover one side of the cell assembly accommodated in the module case and guide connection of electrode leads of the plurality of battery cells, and a terminal busbar electrically connected to the battery cells and configured for electrical connection to an outside;
an insulating cover configured to cover the busbar frame and electrically insulate the electrode leads of the battery cells from the module case, and having a terminal hole through which an end portion of the terminal busbar passes; and
a sealing member hook-coupled to the insulating cover, and configured to seal a gap between the terminal busbar and the terminal hole.

13. The module case assembly according to claim 12, wherein
the seal includes a hook protruding in one direction, and
the insulating cover includes a hook-catching groove into which the hook is inserted and coupled, the hook-catching groove being formed such that the hook is inserted upward from below.

14. The module case assembly according to claim 13, wherein the hook is formed to have a rectangular cross-section.

15. The module case assembly according to claim 13, wherein
the insulating cover is provided with a terminal through-hole through which the terminal busbar passes, and
the hook is disposed below the terminal through-hole.

16. The module case assembly according to claim 15, wherein the seal includes a coupling protrusion disposed on a side opposite to the hook with the terminal through-hole interposed therebetween, and configured to be coupled to the insulating cover.

17. The module case assembly according to claim 16, wherein the insulating cover is provided with a coupling groove into which the coupling protrusion is forcibly fitted.

18. The module case assembly according to claim 17, wherein the sealing member includes:
a body provided with the terminal through-hole and attached to one surface of the insulating cover facing the busbar frame,
an upper wing formed to extend upward from the body and provided with the coupling protrusion, and
a lower wing formed to extend downward from the body and provided with the hook.

19. The module case assembly according to claim 18, wherein the body includes an O-ring having a ring shape corresponding to the terminal hole, the O-ring protruding toward the opposite side of the busbar frame, passing through the terminal hole, and being in close contact with an inside surface of the terminal hole.

20. The module case assembly according to claim 19, wherein the O-ring includes a fitting groove concavely formed along a circumferential direction, into which the terminal hole is fitted.
